(19) United States
(12) Patent Application Publication
(10) Pub. No.: US 2019/0126156 A1
(43) Pub. Date: May 2, 2019

(54) WALL-INSET CHILDRENS DIORAMA

(71) Applicant: Teresa Walker, West Haven, UT (US)

(72) Inventor: Teresa Walker, West Haven, UT (US)

(21) Appl. No.: 15/795,215

(22) Filed: Oct. 26, 2017

(51) Int. Cl. A63H 3/52; A63H 33/26; A63H 3/00; E05B 65/52

(52) U.S. Cl. CPC A63H 3/52; E05B 65/52; A63H 3/00; A63H 33/26

(57) ABSTRACT

A box disposed within a wall of a home of a user, the box including a door disposed on at least a portion of a front of the box to open and close the front of the box, a light disposed within the box, a motion detector to turn the light on in response to detecting motion of at least one of the door and the user, and at least one of a picture disposed on a back wall of the box and an object disposed on a floor of the box.

### BACKGROUND OF THE INVENTION

### 1. Field of the Invention

The present general inventive concept relates generally to a children's diorama, and more specifically to a children's diorama inset within a wall.

### 2. Description of the Related Art

Children often enjoy stories of fantasy, adventure, magic, mysticism, and surrealism. For example, parents often regale their children with legends about superhuman knights, wizards, giants, fairies, and other mythical beings. However, these tales are typically only portrayed through verbal storytelling, books, and movies. As such, children are limited to using their eyes or imaginations to visualize the beings in fairytales. In other words, children cannot physically touch or manipulate the worlds in which mystical creatures reside, nor can children touch the mystical creatures themselves. Accordingly, children's imaginations are somewhat halted, stunted, and limited, because reality often sets in, and they stop believing in magic and cease using the imaginative portions of their brains. In effect, children nowadays “grow up” too fast.

Therefore, there is a need for a physical manifestation of enchanted creatures and the domains in which they reside.

There is also a need for a novelty that sparks the imagination of children.

There is also a need for a novelty that supports parents' stories, thereby of stimulating children with hopes of seeing and touching being similar to the ones heard in their favorite fairytales.

### SUMMARY

The present general inventive concept provides a wall-inset children's diorama.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a box disposed within a wall of a home of a user, the box including a door disposed on at least a portion of a front of the box to open and close the front of the box, a light disposed within the box, a motion detector to turn the light on in response to detecting motion of at least one of the door and the user, and at least one of a picture disposed on a back wall of the box and an object disposed on a floor of the box.

The box may further include a textured surface on a floor on the box.

The light may be disposed on at least one of a ceiling of the box and a back wall of the box.

The motion detector may be disposed on at least one of the light and the door.

The picture may depict at least one of a fairy, an elf, a dwarf, a leprechaun, a knight, a ghost, a giant, and a wizard.

The at least one object may include at least one of furniture, rocks, mirrors, weaponry, nature-related objects, creatures, shelves, pots, fireplaces, and birdhouses.

The door may include a locking mechanism to lock the door, and a handle to allow the user to open the door.

The box may further include at least one figurine disposed on the floor of the box.

The at least one figurine may include at least one of a fairy, an elf, a dwarf, a leprechaun, a knight, a ghost, a giant, and a wizard.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a box having a door, according to an exemplary embodiment of the present general inventive concept;

FIG. 2 illustrates the box with the door open with a diorama thereinside, according to an exemplary embodiment of the present general inventive concept; and

FIG. 3 illustrates a closed door disposed on the wall, according to another exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

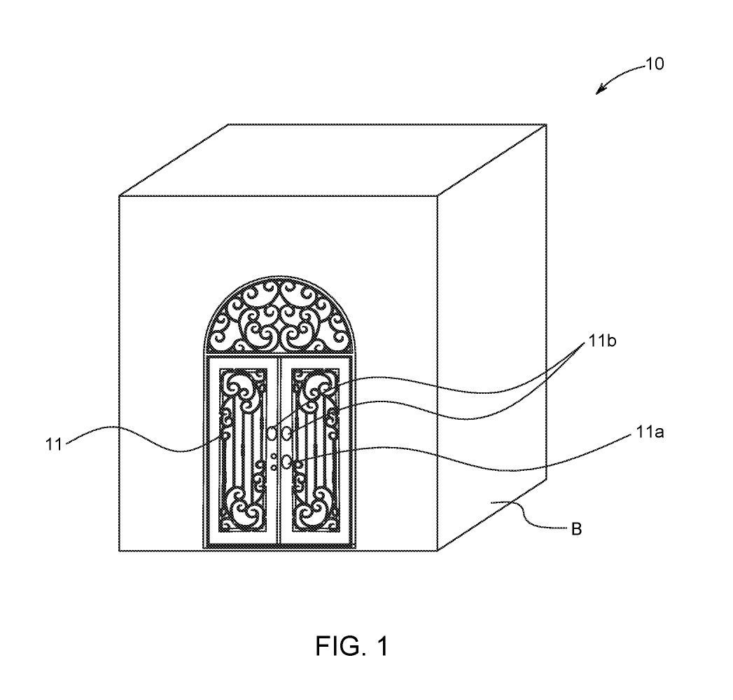

FIG. 1 illustrates a box 10 having a door 11, according to an exemplary embodiment of the present general inventive concept.

Referring to FIG. 1, the box 10 may be constructed from plastic, wood, metal, ceramic, or any other material known to one of ordinary skill in the art. Also, the box 10 may have any shape, color, design, or texture.

The box 10 may be insertable within a wall 1 of a user's home. More specifically, the user may cut away a portion of the wall 1 between two studs, which is large enough to house the box 10 therein.

The door 11 may have any shape, color, design, or texture, and may include one door opening from one side, or a plurality of doors opening from two different sides.

The door 11 may cover an entire front surface of the box 10, or may cover only a portion of the front surface of the box 10.

The door 11 may include a locking mechanism 11 a and a handle 11b. The locking mechanism 11a may function to lock the door 11, and the handle 11b may function to aid the user in opening the door 11.

The locking mechanism 11a may be opened with a key, a combination lock, a touchpad, a keypad, a fingerprint unlocking mechanism, or any other type of opening mechanism known to one of ordinary skill in the art.

The handle 11b may be any type of handle, including a stationary handle, a twisting handle, a knob, or any other type of handle known to one of ordinary skill in the art.

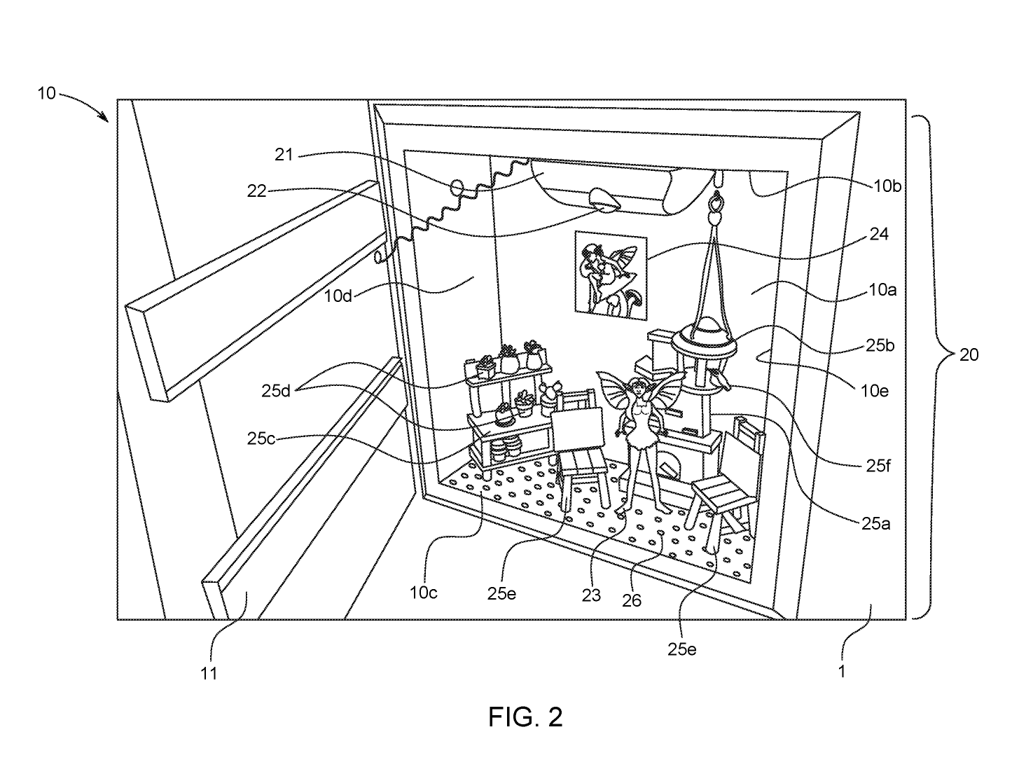

FIG. 2 illustrates the box 10 with the door 11 open with a diorama 20 thereinside, according to an exemplary embodiment of the present general inventive concept.

Referring to FIG. 2, when the door 11 is open, an inside portion of the box 10 may be visible to the user.

The inside portion of the box 10 may have a back surface 10a, a ceiling 10b, a floor 10c, a left wall 10d, and a right wall 10e.

The diorama 20 may be designed to have a theme of fantasy, fairytales, magic, adventure, medieval times, or any other type of theme.

The diorama 20 may include a light 21, a motion detector 22, at least one figurine 23, at least one picture 24, at least one object 25, and a surface 26.

The light 21 may be of any color, shape, bulb-type, or brightness. The light 21 may be disposed on the ceiling 10b of the box 10.

The motion detector 22 may be connected to the light 21, and may function to turn on the light 21 when the door 11 is opened, or alternatively, when it senses a movement of the user.

The motion detector may be disposed on the light 21 or the door 11, but is not limited thereto.

The at least one figurine 23 may be any type of figurine depicting a being from a fairytale, including, but not limited to, a fairy, an elf, a dwarf, a leprechaun, a knight, a ghost, a giant, a wizard, or any other type of figurine known to one of ordinary skill in the art. However, the at least one figurine 23 is not limited to beings from fairytales.

The at least one figurine 23 may be disposed anywhere within the inside portion of the box 10, including, but not limited to, the floor 10c, or suspended from the ceiling 10b.

The at least one picture 24 may be an illustration of anything desired by the user, but preferably an illustration of a being from a fairytale, including, but not limited to, a fairy, an elf, a dwarf, a leprechaun, a knight, a ghost, a giant, a wizard, or any other type of bring from a fairytale known to one of ordinary skill in the art. However, the at least one picture 24 is not limited to illustrating beings from fairytales.

The at least one picture 24 may be disposed anywhere within the inside portion of the box 10, including, but not limited to, the back surface 10a, the left wall 10d, and the right wall 10e.

The light 21 may illuminate the at least one picture 24 when the light 21 is turned on.

The at least one object 25 may be an object related to the theme of the diorama 20. For example, the at least one object 25 may include furniture, rocks, mirrors, weaponry, nature-related objects, creatures, shelves, pots, fireplaces, birdhouses, etc., but is not limited thereto.

Referring to FIG. 2, the at least one object 25 is depicted in plurality as a fireplace 25a, a birdhouse, 25b, a shelve 25c, pots 25d, a plurality of chairs 24e, and a bird 25f.

The surface 26 may have any type of color or texture, and may depict stones, moss, grass, wood, etc., but is not limited thereto.

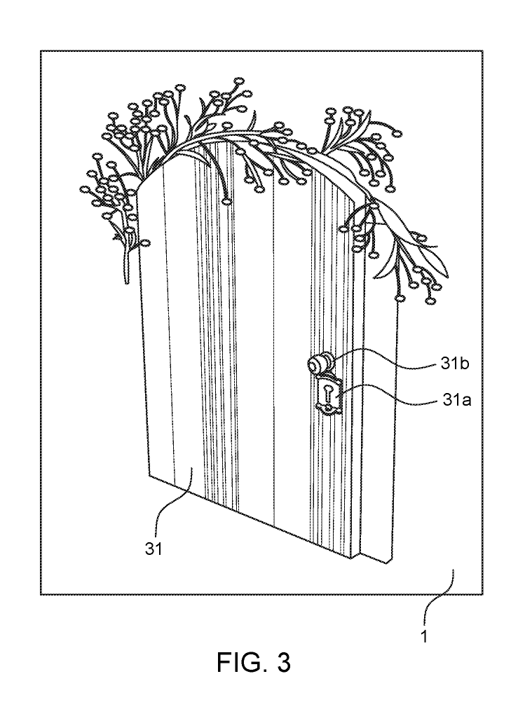

FIG. 3 illustrates a closed door 31 disposed on the wall 1, according to another exemplary embodiment of the present general inventive concept.

Referring to FIG. 3, the closed door 31 is a single door that opens from one side.

The closed door 31 may include a locking mechanism 31a and a handle 31b.

The locking mechanism 31a may function to lock the door 31, and the handle 31b may function to aid the user in opening the door 31.

The locking mechanism 31a may be opened with a key, a combination lock, a touchpad, a keypad, a fingerprint unlocking mechanism, or any other type of opening mechanism known to one of ordinary skill in the art.

The handle 31b may be any type of handle, including a stationary handle, a twisting handle, a knob, or any other type of handle known to one of ordinary skill in the art.

Although not illustrated in FIG. 3, the box 10 and the diorama 20 of FIGS. 1 and 2 may be included within the wall 1 and behind the door 31, such that the diorama 20 is exposed when the door 31 is opened.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A box disposed within a wall of a home of a user, the box comprising:
a door disposed on at least a portion of a front of the box to open and close the front of the box, such that the door is substantially flush with the wall when the door is closed;
a light disposed within the box;
a motion detector to turn the light on in response to detecting motion of at least one of the door and the user; and
at least one of a picture disposed on a back wall of the box and an object disposed on a floor of the box.

2. The box of claim 1, further comprising:
a textured surface on a floor on the box.

3. The box of claim 1, wherein the light is disposed on at least one of a ceiling of the box and a back wall of the box.

4. The box of claim 1, wherein the motion detector is disposed on at least one of the light and the door.

5. The box of claim 1, wherein the picture depicts at least one of a fairy, an elf, a dwarf, a leprechaun, a knight, a ghost, a giant, and a wizard.

6. The box of claim 1, wherein the at least one object comprises at least one of furniture, rocks, mirrors, weaponry, nature-related objects, creatures, shelves, pots, fireplaces, and birdhouses.

7. The box of claim 1, wherein the door comprises:
a locking mechanism to lock the door; and
a handle to allow the user to open the door.

8. The box of claim 1, further comprising:
at least one figurine disposed on the floor of the box.

9. The box of claim 8, wherein the at least one figurine comprises at least one of a fairy, an elf, a dwarf, a leprechaun, a knight, a ghost, a giant, and a wizard.

10. A box disposed within a wall of a home of a user, the box comprising:
a door disposed on at least a portion of a front of the box to open and close the front of the box, such that the door is substantially flush with the wall when the door is closed;
a light disposed within the box;
a motion detector disposed on at least one of the light and the door, the motion detector to turn the light on in response to detecting motion of at least one of the door and the user; and
at least one of a picture disposed on a back wall of the box and an object disposed on a floor of the box.
